(19) United States
(12) Patent Application Publication
(10) Pub. No.: US 2007/0274777 A1
(43) Pub. Date: Nov. 29, 2007

(54) Connecting Unit

(75) Inventor: Wilhelm Winkler, Meerbusch (DE)

Correspondence Address: HARNESS, DICKEY & PIERCE, P.L.C., P.O. BOX 828, BLOOMFIELD HILLS, MI, 48303, US

(73) Assignee: Spirit2go GmbH, Frankfurt am Main (DE)

(21) Appl. No.: 10/590,852

(22) PCT Filed: Feb. 25, 2005
(86) PCT No.: PCT/EP05/01983

§ 371 Date: Jul. 26, 2007

(30) Foreign Application Priority Data
Feb. 26, 2004 (DE) 20 2004 002 953.7

(51) Int. Cl. F16B 2/14

(52) U.S. Cl. 403/374.1

(57) ABSTRACT

The invention relates to a connecting unit which is used to quickly connect various types of components or to quickly fix components to other components and which can be detached in an easy and quick manner with simple means even when there is a large amount of dirt or corrosion and which can provide a reliable, permanent connection. The inventive connecting unit comprises a journal provided with at least two stops with a joint area arranged between the stops and a counter element interacting with the stops of the journal. The counter element has a recess for the joint area of the journal and a wedge-shaped outer contour which is formed by outer surfaces of the counter elements oriented perpendicular to the longitudinal axis of the journal when the journal and counter element are joined together in an appropriate manner.

The invention relates to a connecting unit with a journal and a counter element that interacts with the journal. The connecting unit provides a releasable connection of several components and an attachment of several components to an apparatus provided with a connecting unit in accordance with the invention.

Connecting units of this kind are known from the prior art. They are divisible into releasable units and non-releasable units. Examples of releasable connecting units are nut-screw connections or bolt-wedge connections known from half timber building construction or, for example, from scaffolding construction.

With screw connections, the to be connected together components include through holes placed at appropriate locations. The screws are pushed through these through holes until the head of the screws lie against one of the to be connected components. The length of the screw is sized such that it extends through the to be connected components. A nut is screwed onto the free end of the screw that is opposite to the head and that is provided with threads, and if need be, appropriate washers and/or spring washers are intermediately inserted. Through the tightening of the nut on the threads of the screw, the to be coupled together components are pressed against each other in a known manner between the screw head and nut as a result of the ascension of the threads. In addition to a screw provided with a head, the use of a stanchion material provided with a thread, together with nuts is known. It is likewise known, to provide a structure having threads on building elements of various types, so that various components are fixed by means of a nut that fits the thread.

Screw connections are used in several areas of the art in multiple embodiments and variations. It is disadvantageous with the known prior art connections that these connections are only releasable with very great effort or are even not at all releasable, because of being bound together by fouling or corrosion, for example. If the free-lying thread area of the screw, which is not covered by the nut, is exposed to wear, the free-lying thread areas of the screw, as well as the tool attachment surfaces of the nut are subjected to a not insubstantial wear, which can lead to unusability and/or complete deterioration of this structure. This is, for example, the case with screw connections of agricultural machines, with which the screw connections come into contact with sand and dirt, and are run through this sand and dirt. The result is that this connections are no longer releasable by means of the tool provided for this purpose and, for example, must be destroyed with cut-off grinding in order to release the components from one another, which are bound together with the connections. Even in cases in which corrosion or wear still have not lead to a complete binding of the connections and deterioration of its outer structure, it is in any case necessary to thoroughly remove adhering dirt before release of the connections, because this dirt can be carried into the space between the nut and the screw, particularly with a loosening of the nut, and there can lead to a destruction of the threads and a difficult loosening up to binding. Already light deformation of the threads of the screw and/or nut can clearly make difficult or impede a release of the connection.

Likewise, wedging of various types are known from the prior art. Examples of wedging are seen in the half-timber building construction and/or in the modern scaffolding construction. These types of wedges have a journal like element, which is inserted through openings in the to be connected elements. The journal-like element includes a stop forming contour at one end. This contour can be formed either through a head of a journal like element or through various other contours that broaden the diameter of the element. The journal like element is provided with a through opening at the end opposite to the stop, which runs perpendicular to the longitudinal axis. The location and the dimensions of the through hole are determined based on the strength of the to be connected together elements as well as on the dimensions of a wedge shaped counter element. The wedge shaped counter element is driven through the through hole found in the journal element and is wedged with the through hole and the surrounding body edges of the to be connected components as a result of its wedge shaped form.

It is disadvantageous with such wedge connections known from the prior art that the to be connected components between the wedge and journal are formed relatively small in the force transferring cross-section, so that the through hole found in the wedge or journal element can deform as a result of the higher existing compressive stresses and the connection is disadvantageously difficult to release. The through hole found in the journal element tends to be plagued with dirt particles with an insertion in dirty environments.

Starting from this known prior art, it is the object of the present invention to provide a connecting unit to enable quick connection of various components together or to quickly fix components to other components, which are easily and quickly releasable with simple means even when there is a large amount of dirt or existing corrosion, and at the same time achieves a safe and durable fixed connection.

This object is achieved through the invention by a connecting element, which includes a journal provided with at least two stops and with a joint area located between the stops, and a counter element that cooperates with one of the stops of the journal, wherein the counter element includes a recess for the joint area of the journal and a wedge shaped outer contour, which is formed by outer surfaces of the counter element that are oriented perpendicular to the longitudinal axis of the journal when the journal and the counter element are joined together in an appropriate manner.

Using the connecting unit of the invention, the to be connected components include through holes. The dimensions of these through holes are determined based on the dimensions of the journal of the connecting unit. The dimensions of the journal and the stops of the journal are in this manner so dimensioned, such that the journal and one of the stops is insertable through the through holes of the to be connected components, while the remaining stop is dimensioned such that it is not insertable through the through holes of the components and forms a stop that impinges against the end side component. The length of the journal as well as the position and length of the joint area between the stops of the journal are likewise determined based on the strength and quantity of the to be connected components. The position and the dimensions of the joint area are determined such that the joint area is positioned with appropriate placing of the journal in the through holes of the to be connected together components inside and partially outside of the through holes of an end side placed component.

The strength of the counter element that cooperates with the journal as well as the wedge shaped outer contour thereof are likewise determined based on the location and dimensions of the joint area of the journal, the location and dimensions of the stops as well as also the dimensions of the to be connected together components. For connection of the components, the journal is inserted through the through holes located in the components until the larger of the two stops rests against a body contour of one of the components. In this position, the end of the journal that is opposite to the larger stop sticks out through the through hole of the opposing component, so that the joint area of the journal is located partially inside and partially outside of this through hole. The wedge shaped counter element is slidable onto the joint area of the so placed journal. Through the above explained matching of the counter element with the to be connected components and the journal, the structure formed from the journal, the counter element and the to be connected components is wedgeable. In this manner, the counter element abuts the smaller of the two stops of the journal. Contingent upon its wedge shaped outer contour, the counter element binds with the smaller of the stops of the journal and the component that is adjacent to the counter element. The strength of this binding is determined by the magnitude of the incline of the wedge shaped outer contour of the counter element, its magnitude thickness as well as its position relative to the journal. The binding force effected through the binding of the counter element and the smaller of the stops is transferred through the journal to the other stop of the journal and through this, into the to be connected components. In order to influence the strength of the binding of the connecting unit with the to be connected components, the counter element is driven onto the journal with one or more blows of an appropriate tool. A secure and durable connection of the components and of the connecting unit is ensured through the binding force that is achieved in this manner. Loadings that occur during practical use of this type of connections, like vibrations for example, do not lead to a loosening of the connecting unit as a result of the high achievable binding forces. The connecting unit is advantageously adaptable to any strong loading through an appropriate dimensioning of the journal and the counter element. To release the connecting unit, it is sufficient to execute one or more blows with an appropriate tool against the counter element opposite to its joining direction with the journal. Thus, the binding between the journal and the counter element of the connecting unit on the one hand and the to be connected components on the other hand is released. When the connecting unit is in circumstances of deposited dirt and corrosion a rapid release of the connecting unit is not impeded.

Naturally, it can likewise be envisaged that the journal of the connecting unit is provided as a journal formed appendage of any component. Similar to an above described journal, such a journal shaped appendage likewise includes a joint area located between two stops. One of the stops can advantageously be formed through a contour of the component, which includes the journal formed appendage. While the journal of the connecting unit is provided as a journal formed appendage of a component, any other components are attachable to the journal carrying component by means of the connecting unit of the invention.

A further embodiment of the invention provides that the recess of the counter element has a wedge like taper in the direction of the increasing thickness of the wedge shaped outer contour and the joint area of the journal is wedge like formed corresponding to the recess of the counter element. With a connecting unit of this kind, the incline of the wedge shaped outer contour runs opposite to the incline of the recess. Through the opposing inclines of the two contours, a safe and durable holding binding of the counter element and the journal is ensured and advantageously achieved, while too strong of a binding and/or too large of a driving on of the counter element onto the journal is prevented through the opposite running inclines of the recess. The binding forces existing in the connecting unit and between the connecting unit and the to be connected components are precisely and reproducibly selectable with a connecting unit of this kind. Too deep of a sliding on of the counter element onto the journal and a corresponding plastic deformation of the counter element and/or journal is advantageously prevented. The joint area of the journal is wedge like formed compatible to the recess of the counter element. In this manner, the surface pressure between the journal and the counter element, which can become large enough to damage the journal or the counter element, is prevented. The clamping force present between the counter element and the journal is transferred to a comparatively large surface through the relative to one another compatibly dimensioned wedge contour of the joint area of the journal as well as the recess of the counter element, which leads to a reduction of the existing surface pressures.

A particular advantageous embodiment of the invention is provided in that the joint area is formed by grooves that are provided in the journal. The grooves are oriented relative to one another such that the joint area includes the wedge shaped cross-section already described above. Thus, the joint area can be formed through two grooves, for example, that are located on the journal lying opposite to one another. It is likewise envisaged, that more than two grooves are formed in the journal. Thus, the formation of four joint areas with wedge shaped cross-sections, for example, can be provided through the placement of eight grooves in the journal. These joint areas are placed at different angular positions relative to one another, so that several alternatives exist, four alternatives in the described example, to place the counter element on the journal. The base surfaces of the grooves run parallel to the longitudinal axis of the journal and are wedge shaped relative to one another. In accordance with a further embodiment, at least two grooves are formed in the shaft. These grooves advantageously lie opposite to one another.

In accordance with a further embodiment of the invention, the journal includes a head and a shaft. The head and the shaft are so dimensioned, such that the head of the journal can form the larger of the two stops of the journal. The head can include a form that is adapted to the respective implementation of the connecting unit. In this connection, cylindrical formed heads with various circumferential contours are anticipated, for example, round, tetragonal or hexagonal heads. The head of the shaft can likewise be formed as a countersunk head or a lentoid head. The dimensions of the shaft, i.e., its cross-sectional shape, diameter and length, are determined based on the dimensions of the to be connected together components. The cross-section of the shaft includes various types, for example, the shaft includes a round, tetragonal or quadratic cross-section. A joint area is formed in the shaft of the journal. Instead of the head of the journal, a second joint area can alternatively be provided, on which a second counter element is slidable. This second counter element functions as a stop instead of the head.

In accordance with a further advantageous embodiment of the invention, the side surfaces of the grooves that run in the radial direction of the longitudinal axis are at a right angle in the tangential direction. Grooves of this kind are formable in the journal in a simple way and manner, by, for example, a finger cutter that is traversed in a known manner perpendicular to the longitudinal axis of the journal with corresponding in-feeding. Journals with this kind of groove forms are combinable with counter elements with various wedge angles and have a broad spectrum of use. Alternatively, it can be provided that the side surfaces of the grooves running in the radial direction are sloped at the wedge angle of the wedge shaped outer contour of the counter element relative to a plane that runs perpendicular to the longitudinal axis of the journal. By means of these kind of sloped side surfaces of the groove it is advantageously achieved that the counter element flatly abuts the side surfaces that form the stop of the journal. In this manner, the clamping force that is necessary to ensure binding of the connecting unit is distributively transferred to as large a surface as possible and minimizes the existing surface pressures.

In accordance with a further inventive form, the recess of the counter element is formed by a wedge shaped notch. The slope angle of the wedge shaped notch corresponds to the slope angle of the joint contour of the journal that is used with the counter element. A counter element of this type is quickly slidable onto the journal in a simple manner, even under difficult access conditions, and is easily bound with the journal.

Alternatively, it is envisaged that the recess of the counter element is formed by an extended wedge-shape tapered through hole in the counter element that is perpendicular to the direction of penetration. The cross-section of the through hole is so dimensioned, such that an unproblematic and simple insertion of the journal of the counter element with the smaller of the stops is possible. Advantageously, a counter element of this kind prevents its being lost upon release of the connecting unit, because the seating of the counter element on the journal is ensured with high certainty even in a non-wedged condition. Furthermore, the assembly and fixing of the connecting unit and the counter element on the journal can be eased even under difficult access conditions, while the counter element is initially only loosely placed on the journal by means of its through hole and remains there with a sufficiently high certainty and then is subsequently wedged with the journal.

It is advantageously provided that the recess is formed by two circular formed through holes that are spaced apart form one another and a wedge shaped area that connects the through holes with one another. A recess structure of this kind is simple and cheaply manufacturable using traditional means. Moreover, this kind of formation of the recess of the counter element offers the possibility that the wedge shaped tapering surfaces of the wedge shaped area can be re-worked in a simple manner after lengthy use in potentially present wear or damage. This is particularly the case when the two circular through holes include a diameter that is larger than the maximum and/or minimum spacing of the surfaces that form the wedge shaped area.

A particularly advantageous embodiment of the connecting unit of the invention includes a balance element. This balance element can be formed with various outer contours, but advantageously includes, however, a shape similar to the counter element. The balance element includes a slope that is inverse to the slope of the counter element. If the balance element and the counter element are placed on the journal in an intended manner, the side surfaces of the counter element and the balance element, which digress from one another, run parallel to one another. In this manner, a stable and also positive fitting, with the existence of corresponding dimensions, connection of counter and balance element with the journal and the to be connected components is enabled. A transfer of the connecting and binding forces between the respective elements of the connecting unit and the to be connected components is advantageously achieved through laminar partial surfaces lying atop one another and stops of the element, wherein a good transfer of these forces is ensured and the existing surface pressures are minimized.

In accordance with a further advantageous embodiment of the invention, the balance element is slidable onto the journal adjacent to the counter element. For this purpose, the dimensions of the joint area of the journal are determined based on the dimensions of the counter element and the balance element.

In accordance with a further advantageous embodiment of the invention, the counter element includes two wedge shaped elements with opposed inclines. These elements are coupled together in an appropriate manner, so that a displacement of the elements relative to one another is possible with operation. At the same time, it can be envisaged that the elements are linearly displaced relative to one another or are alternatively skewed relative to one another so that, in this manner, the entire strength of the counter element for effecting appropriate binding forces can be varied.

In accordance with a further advantageous embodiment, the connecting unit includes a securing element for securing the counter element on the journal. This securing element can be realized, for example, in the form of a rubber plug, which is insertable in the remaining joint area between the counter element and journal upon intended assembly of the counter element and the journal, and which prevents a loss of the counter element upon a possible unintended release. In particular, however, the securing element protects against fouling. No dirt, in particular no hardened dirt, penetrates into the free space, which could impede a release. Naturally, the securing element can comprise each of various appropriate materials. Advantageously, materials with corresponding elastic properties are used for the securing element, which conforms to the remaining space between the counter element and the journal and wedges itself therein upon insertion as a result of its elasticity. For the case in which the securing element should counter an independent disengagement, it is advantageously constructed to be harder.

The connecting unit of the invention can naturally be made from various materials. Likewise, combinations of materials are anticipated. In this connection, the use of metal, plastics of various types, wood or composite materials is identified. The selection of the respectively used materials occurs in accordance with material specific properties and is tailored to the respective use of the connecting unit of the invention. Thus, for example, the elasticity of the implemented material influences the durability of the connection and/or its disengageability. The use of plastics offers possibilities in relation to weight optimization. With the use of metal materials for the connecting unit of the invention, the possibility to use various metal materials likewise naturally exists.

Further characteristics and features of the present invention are provided from the several preferred exemplary embodiments in the following description along with the figures. These exemplary embodiments serve only for explanatory purposes and are not limiting. It is shown in:

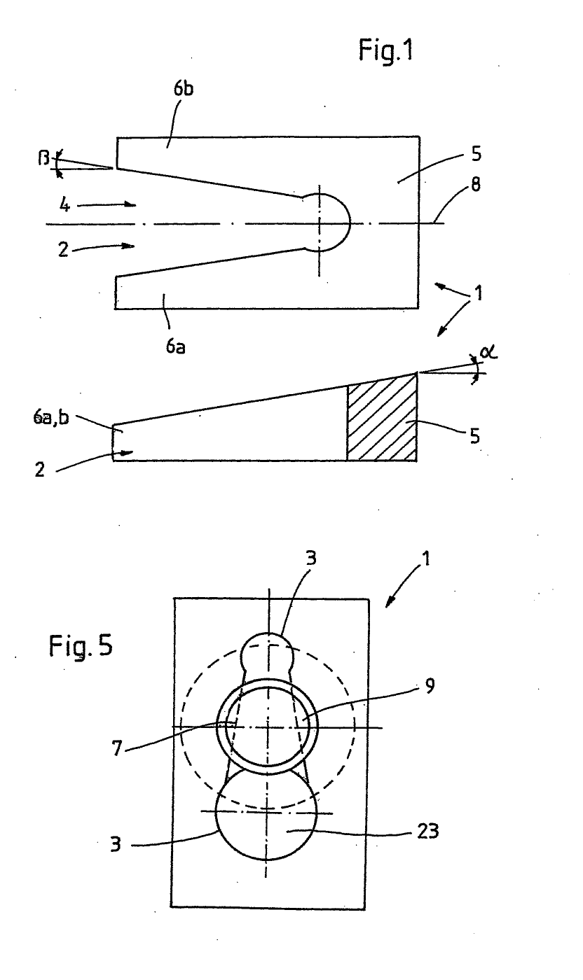

FIG. 1 a counter element of the invention in a plan view and a side sectional view,

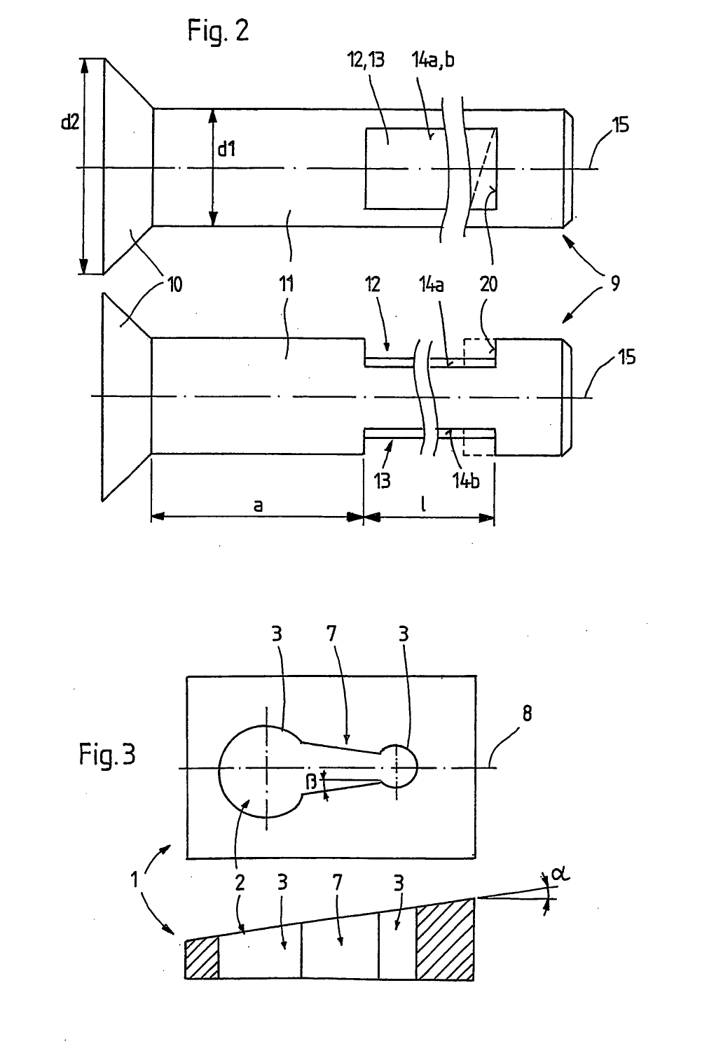

FIG. 2 a journal of the invention in two side views rotated at 90°,

FIG. 3 a second embodiment of the counter element of the invention in a plan view and a sectional view,

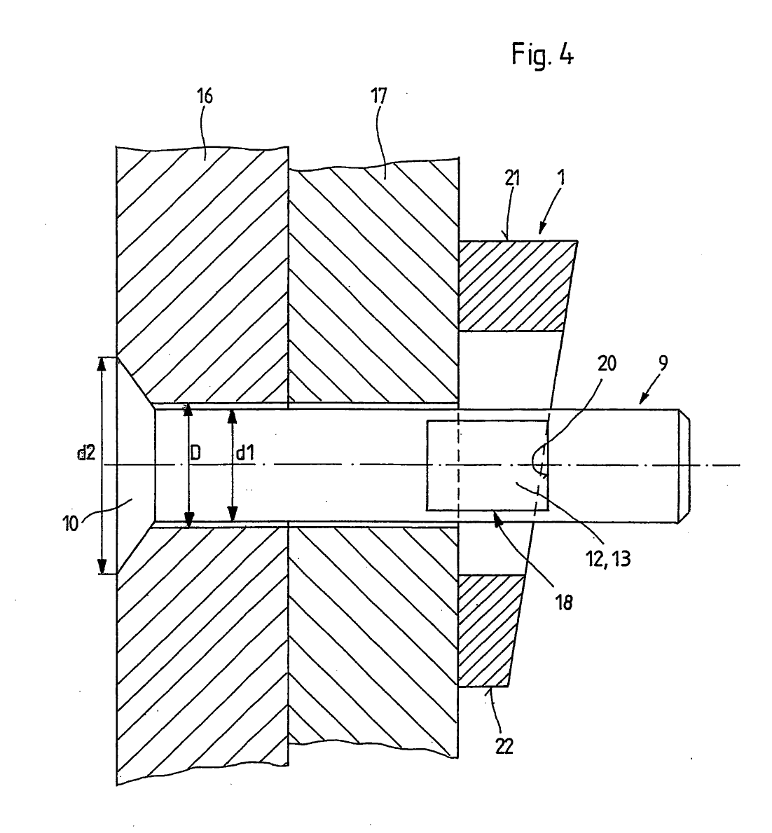

FIG. 4 the connecting unit of the invention in an assembled condition for connecting two components in a side sectional view,

FIG. 5 the connecting unit of the invention in an assembled condition in plan view,

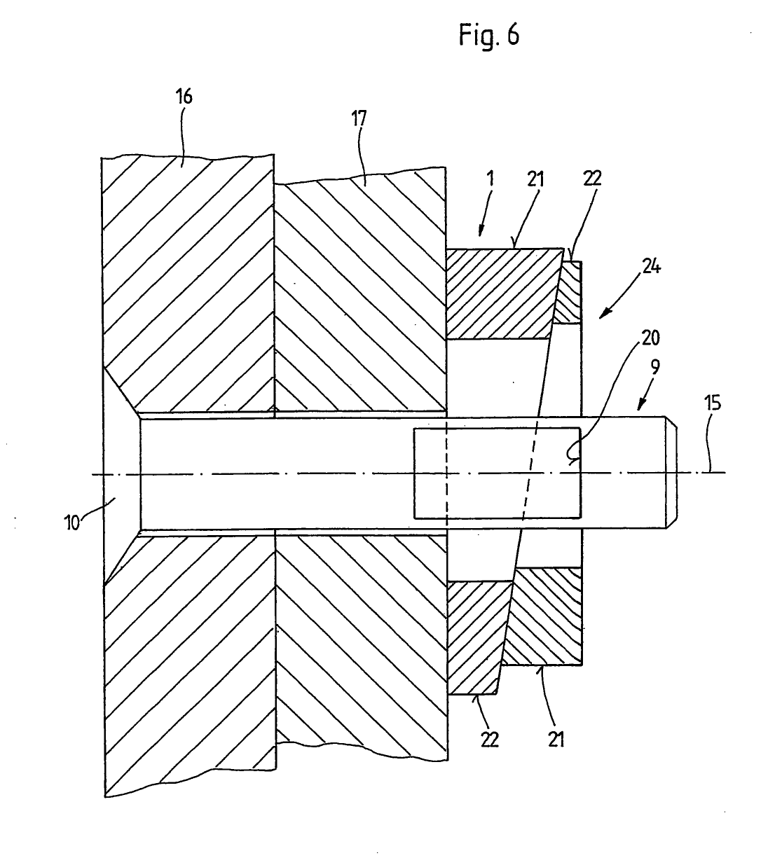

FIG. 6 the connecting unit of FIG. 4 in an assembled condition with a balance element,

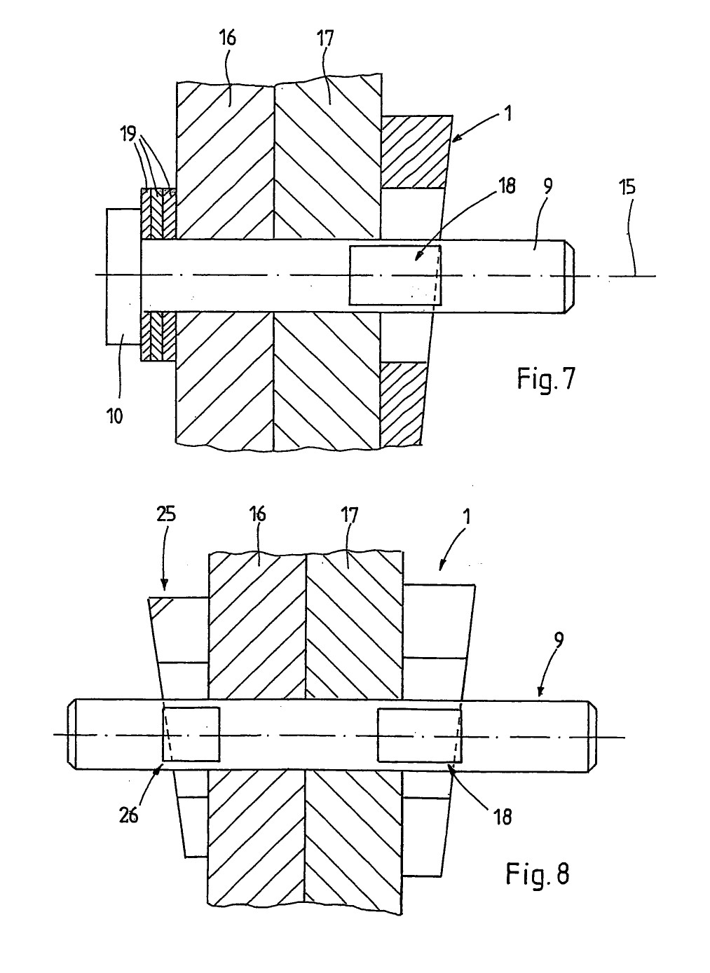

FIG. 7 the use of a connecting unit of the invention with spacing elements,

FIG. 8 a further embodiment of the connecting unit of the invention in an assembled condition in a side sectional view,

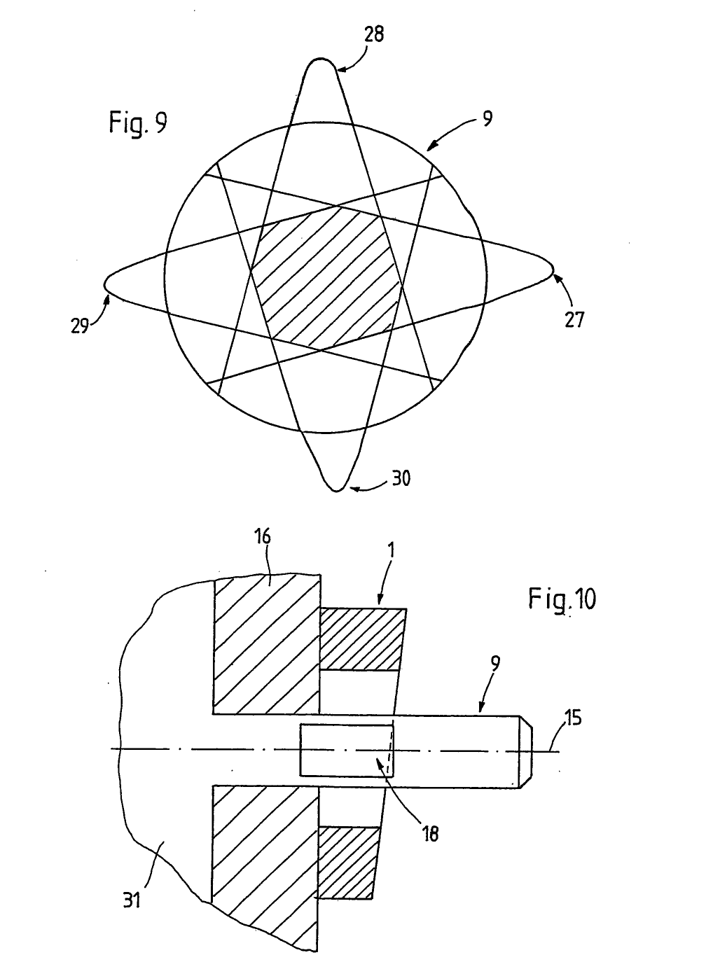

FIG. 9 a cross-section through the joint area of a journal of a connecting unit of the invention with several wedge formed joint contours that are placed in different angular position relative to one another, and

FIG. 10 a further embodiment of the connecting unit of the invention.

The counter element 1 of the connecting unit 1 of the invention is illustrated in FIG. 1. The counter element 1 has a rectangular outer surface and is provided on one side with a recess 2. The recess 2 is formed by a wedge shaped notch 4. The counter element 1 includes a substantially U-shaped form with a connection area 5 and two lateral appendages 6a, 6b. An alternative, however, preferred embodiment of the contour element 1 is illustrated in FIG. 3. With this embodiment the outer contour 2 of the counter element 1 is formed by two through holes 3. The through holes 3 include a different diameter and are connected with one another by means of a wedge shaped connection area 7. Both the wedge shaped notch 4 of the counter element 1 in FIG. 1 and the wedge shaped connection area 7 of the counter element 1 illustrated in FIG. 3 are sloped at a wedge angle β relative to the longitudinal axis 8 of the counter element 1. In the sidewise sectional view in FIG. 1 and FIG. 3, one recognizes that the outer surface of counter element 1 is likewise formed in a wedge shape. The incline angle of the wedge shaped outer surface of the counter element 1 is indicated with α. What is important is that, as recognizable in FIGS. 1 and 3, the slope angles α and β include opening angles positioned relative to one another. That means that with decreasing width of the recess contour 2, more precisely of the wedge shaped notch 4 and/or of the wedge shaped connection area 7, the material strength of the counter element 1 increases as viewed in the sidewise cross-section.

A journal 9 of the connecting unit of the invention is illustrated in FIG. 2. The journal includes a head 10 and a shaft 11. The shaft 11 is provided with two grooves 12, 13. The gap a of the grooves 12, 13 from the head 10 of the journal 9 as well as the length l of the groove are determined based on the dimensions of the respective to be connected components. One recognizes that the base surfaces 14a, 14b of the grooves 12, 13 run parallel to the longitudinal axis 15 of the journal 9, however, they are sloped relative to one another. The slope angle γ existing between the base surfaces 14a, 14b of the grooves 12, 13 corresponds to twice the value of the wedge angle β of the counter element 1. The head 10 of the journal 9 is formed as a counter sunk head in the illustrated embodiment, however, can include various other cross-sectional forms.

The connecting unit of the invention in the assembled condition for connecting two components 16, 17 is illustrated in FIG. 4. The components 16, 17 include through holes. The journal 9 of the connecting unit of the invention is pushed through these through holes until the head 10 of the journal 9 abuts a stop formed at a correspondingly formed contour of the component 16. The journal 9 can be centerable relative to the component by means of the head 10. The joint area 18 of the journal 9 that is formed by the grooves 12, 13 lies partially within the through holes of the component 17 and partially outside of this through hole. By a variation of the groove length l as well as of the gap a of the connecting area 18 from the head 10 of the journal 9, each of the connecting unit and the journal 9 is adaptable to differing thickness dimensions of the components 16, 17. As illustrated in FIG. 6, this adaptation at different dimensions of the to be connected components 16, 17 can likewise be realized by intermediate insertion of appropriate spacer elements 19. The counter element 1 abuts the component 17 with its wedge shaped outer contour on the one hand and the journal-side side surface 20 formed by the grooves 12, 13, which functions as a second stop, on the other hand. The connecting unit of the invention is wedgable by one or more blows with a hammer on the side surface of the counter element 1, which is indicated with 21, and is again releasable by blows on the side surface of the counter element 1, which is indicated with 22.

As illustrated in FIG. 2, the radial side surfaces 20 of the grooves 12, 13 run parallel to one another and at a right angle to the longitudinal axis 15 of the journal 9. As illustrated in FIG. 2 with help of the dashed line, the possibility exists that the journal-side radial side surfaces 20 of the grooves 12, 13 run at an angle of 90°+α relative to the longitudinal axis 15 of the journal. In this manner, the progression of the radial side surfaces 20 of the grooves 12, 13 with the intended assembly of the journal 9 and the counter element 1 correspond precisely to the progression of the wedge surfaces of the counter element 1 that slope at the wedge angle α. In this manner, an improved force transfer is ensured between the counter element 1 and the journal 9. Alternative to the sloped progression of the radial side surfaces 20 of the grooves 12, 13, a balance element having a wedge angle α can likewise be used.

As recognizable in FIG. 5, the counter element 1 can be secured to the journal 9 through the intended assembly of the connecting unit by means of a securing element 23. The securing element 23 is preferably made from a material with elastic properties such as, for example, rubber or plastic and is inserted in the through hole 3 of the counter element 1.

A further advantageous embodiment of the connecting unit of the invention is illustrated in FIG. 8. The journal 9 does not include a head 10, as in the described exemplary embodiments, but rather is provided as a stanchion formed element. The journal 9 penetrates two to be connected together components 16, 17, through the through holes provided in the components. The journal 9, as already explained above, is provided with a counter element 1, which cooperates with the joint area 18. Instead of the head 10, the journal is provided with a further joint area 26, onto which a second counter element 25 that is the same as the counter element 1 is slidable. By the sliding on of the counter elements 1, 25, the components 16, 17, the journal 9 as well as the counter elements are compressed against one another and the connecting unit is fixed.

A cross-section that is vertical to the longitudinal axis 15 of the journal 9 is illustrated in FIG. 9. The journal 9 is thereby cut in the area of one of the joint areas 26, 18. Wedge shaped contours are formed in the journal 9, which are respectively offset at 90° relative to one another in the radial direction. The wedge shaped contours are identified by the reference numbers 27, 28, 29 and 30. Overlapping of the wedge shaped contours 27, 28, 29 and 30 results in the cross-sectional profile of the joint areas 18, 26 of the journal 9 identified in hatch in FIG. 9. Counter elements 1, 25 of the invention are insertable in four directions on this type of formed joint area.

A further embodiment of the connecting element of the invention is illustrated in FIG. 10. The journal is formed as a journal shaped appendage of one of various components 31. The journal 9 includes a joint area 18 as already described above. A counter element 1 of the already described form is slidable onto this joint area 18. A component 16 is fixed on the component 31 with help of the journal 9 and the counter element 1.

Capacity calculations, in which a preferred embodiment of a connecting unit of the invention has been compared to a traditional screw connection in accordance with the prior art, show that its maximum capacity lies only approximately 1.7% under that of a comparable screw connection. By variation of the wedge angle, it is possible to produce a connecting unit in accordance with the invention with the same capacity as a traditional screw connection.

1. A connecting unit, which includes a journal provided with at least two stops with a joint area arranged between the stops and a counter element cooperating with one of the stops of the journal,
wherein the counter element includes a recess for the joint area of the journal and a wedge-formed outer contour, which is formed by outer surfaces of the counter element oriented perpendicular to the longitudinal axis of the journal when the journal and counter element are joined together in an appropriate manner.

2. A connecting unit in accordance with claim 1, characterized in that the recess of the counter element includes a wedge shaped taper in the direction of the decreasing thickness of the wedge shaped outer contour and the joint area of the journal is wedge shape formed compatible to the recess of the contour element.

3. A connecting unit in accordance with claim 1, wherein the joint area of the journal is formed by the grooves located in the journal.

4. A connecting unit in accordance with claim 1, wherein the journal includes a head and a shaft.

5. A connecting unit in accordance with claim 4, characterized in that one of the radial oriented side surfaces of the grooves forms one stop and the head of the journal forms the other stop.

6. A connecting unit in accordance with claim 3, wherein the base surfaces of the grooves run parallel to the longitudinal axis of the journal and run wedge like relative to one another.

7. A connecting unit in accordance with claim 3, wherein at least two grooves are located in the journal.

8. A connecting unit in accordance with claim 3, wherein the grooves lie opposite to one another.

9. A connecting unit in accordance with claim 3, wherein the side surfaces of the grooves running in the radial direction are at a right angle with the longitudinal axis of the journal in the tangential direction.

10. A connecting unit in accordance with claim 3, wherein the side surfaces of the grooves running in the radial direction are sloped relative to a plane at the wedge angle of the wedge shaped outer contour of the counter element, which is perpendicular to the longitudinal axis of the journal.

11. A connecting unit in accordance with claim 1, wherein the recess of the counter element is formed through a wedge shaped notch.

12. A connecting unit in accordance with claim 1, wherein the recess of the counter element is formed by a wedge like tapered through hole in the counter element that extends perpendicular to the insertion direction.

13. A connecting unit in accordance with claim 12, characterized in that the recess is formed by two circular through holes that are spaced from one another and a wedge shaped area that is connected with one of the through openings.

14. A connecting unit in accordance with claim 1, wherein the connecting unit includes a balance element.

15. A connecting unit in accordance with claim 14, characterized in that the balance element is locatable on the journal next to the counter element.

16. A connecting unit in accordance with claim 14, wherein the balance element includes a wedge shaped outer contour.

17. A connecting unit in accordance with claim 14, wherein the wedge angle of the balance element corresponds to the wedge angle of the counter element.

18. A connecting unit in accordance with claim 14, wherein the wedge slope of the balance element is opposite to the wedge slope of the contour element.

19. A connecting unit in accordance with claim 1, wherein the contour element includes two wedge shaped elements with opposing slopes.

20. A connecting unit in accordance with claim 19, characterized in that the wedge shaped elements of the counter element are linearly displaceable relative to one another.

21. A connecting unit in accordance with claim 19, characterized in that the wedge-shaped elements of the counter element are skewable relative to one another.

22. A connecting unit in accordance with claim 1, wherein the connecting unit includes balance elements for the customization of the clamping length that lie between the stops of the journal to different dimensions of the to be connected components.

23. A connecting unit in accordance with claim 1, wherein the connecting unit includes a safety element, for example a rubber plug, for securing the contour element on the journal.

24. A connecting unit in accordance with claim 1, wherein the journal includes two joint areas separated from one another.

25. A connecting unit in accordance with claim 24, characterized in that at least one counter element is locatable on each of the joint areas.

26. A connecting unit in accordance with claim 1, wherein the journal, counter element, spacer element and/or balance element are made from a substantially metallic material.

27. A connecting unit in accordance with claim 1, wherein the journal, counter element, spacer element and/or balance element are made from a substantially plastic material.
